(19) United States
(12) Patent Application Publication
(10) Pub. No.: US 2024/0246015 A1
(43) Pub. Date: Jul. 25, 2024

(54) HONEYCOMB FILTER

(71) Applicant: NGK INSULATORS, LTD., Nagoya-Shi (JP)

(72) Inventors: Yuta KATO, Nagoya-Shi (JP); Shinji KATO, Yokkaichi-Shi (JP); Narimasa SHINODA, Ichinomiya-Shi (JP)

(73) Assignee: NGK INSULATORS, LTD., Nagoya-Shi (JP)

(21) Appl. No.: 18/542,863

(22) Filed: Dec. 18, 2023

(30) Foreign Application Priority Data
Jan. 19, 2023 (JP) 2023-006603

(51) Int. Cl. B01D 46/24; B01D 39/20; B01D 46/82; B01D 53/88; F01N 3/28

(52) U.S. Cl. CPC B01D 46/2455; B01D 39/2093; B01D 46/24491; B01D 46/24492; B01D 46/82; B01D 53/885; F01N 3/2828; B01D 2258/012; F01N 2370/02

(57) ABSTRACT

A honeycomb filter includes a pillar-shaped honeycomb structure having a porous partition wall disposed so as to surround a plurality of cells which serve as a fluid through channel extending from a first end face to a second end face; a plugging portion provided at either an end on the first end face side or the second end face side of the cell; and a catalyst for purifying exhaust gas that is loaded on the partition wall; wherein, in the state where the catalyst is not loaded, the partition wall has a pore volume of 0.07 to 0.30 cc/g of pores having a pore diameter of 10 μm or less, an average pore diameter of 11 to 23 μm, and a porosity of 56 to 65%.

The present application is an application based on JP 2023-006603 filed on Jan. 19, 2023 with Japan Patent Office, the entire contents of which are incorporated herein by reference.

### BACKGROUND OF THE INVENTION

### Field of the Invention

The present invention relates to a honeycomb filter. More specifically, the present invention relates to a honeycomb filter capable of improving exhaust gas purification performance while suppressing an increase in pressure loss.

### Description of the Related Art

Conventionally, a honeycomb filter using a honeycomb structure has been known as a filter for trapping particulate matter in exhaust gas emitted from an internal combustion engine such as an automobile engine. The honeycomb structure includes a partition wall made of porous ceramics such as cordierite and a plurality of cells defined by the partition wall. A honeycomb filter includes such a honeycomb structure provided with plugging portions so as to plug the open ends on the inflow end face side and the outflow end face side of the plurality of cells alternately. In other words, the honeycomb filter has a structure in which inflow cells that are open at the inflow end face side and are plugged at the outflow end face side and outflow cells that are plugged at the inflow end face side and are open at the outflow end face side are arranged alternately with the partition wall therebetween. In the honeycomb filter, the porous partition wall serves as a filter for trapping the particulate matter in exhaust gas (e.g., soot). Hereinafter, the particulate matter contained in exhaust gas may be referred to as “PM”. The “PM” is an abbreviation for “particulate matter.” Further, in order to purify toxic gaseous components other than PM in exhaust gas, the above-described honeycomb filter may be used with a catalyst for purifying exhaust gas loaded on the porous partition wall constituting the honeycomb filter. Hereinafter, a honeycomb filter in which a catalyst for purifying exhaust gas is loaded on the porous partition wall as described above is sometimes referred to as a “catalyst loaded honeycomb filter”.

Due to the recent strengthening of exhaust gas regulations, there is a need to improve exhaust gas purification performance of the catalyst loaded honeycomb filter. In a technique in which a catalyst is loaded on a partition wall of a honeycomb filter to use, there has been proposed an attempt to make the flow of a gas such as exhaust gas passing through the partition wall uniform by sharpening the pore diameter distribution of the porous partition wall to improve pressure loss and trapping efficiency (see, for example, Patent Document 1).
[Patent Document 1] JP-A-2002-219319

The technique of sharpening the pore diameter distribution of the partition wall as in Patent Document 1 is intended to improve pressure loss and trapping efficiency by making the flow of a gas uniform. However, when the pore diameter distribution of the partition wall is made sharper, exhaust gas purification efficiency may be reduced. For example, when the pore diameter distribution of the partition wall is made sharper, the number of small pores having a relatively small pore diameter at the porous partition wall is reduced. When the number of small pores is reduced in this way, in the porous partition wall, a surface area of the pore loaded with a catalyst is reduced and the catalyst load capacity of the partition wall is reduced. Consequently, if the pore diameter distribution of the partition wall is made too sharp, exhaust gas purification efficiency may deteriorate.

In addition, in order to increase the number of small pores while keeping the sharpness of the pore diameter distribution of the partition wall, it is necessary to shift the pore diameter distribution of the partition wall toward the small pore side, and when the pore diameter distribution of the partition wall shifts toward the small pore side, pressure loss of the honeycomb filter increases.

Here, in order to suppress an increase in pressure loss of the honeycomb filter, a measure to increase the large pore having a relatively large pore diameter is conceivable. However, when the large pore is increased, PM trapping performance of trapping PM is deteriorated. In addition, when the pore diameter distribution of the partition wall is shifted toward the small pore side or the large pore is increased as described so far, a porosity of the partition wall may be changed. The porosity of the partition wall affects to the catalyst load capacity of the partition wall and the mechanical strength of the honeycomb filter, so that it is desired to develop a technique capable of improving exhaust gas purification performance without significantly changing the porosity of the partition wall.

The present invention has been made in view of the problems of the prior arts described above. According to the present invention, there is provided a honeycomb filter capable of improving exhaust gas purification performance while suppressing an increase in pressure loss.

### SUMMARY OF THE INVENTION

According to the present invention, a honeycomb filter described below is provided.

[1] A honeycomb filter including: a pillar-shaped honeycomb structure having a porous partition wall disposed so as to surround a plurality of cells which serve as a fluid through channel extending from a first end face to a second end face; a plugging portion provided at either an end on the first end face side or the second end face side of the cell; and a catalyst for purifying exhaust gas that is loaded on the partition wall; wherein, in the state where the catalyst is not loaded, the partition wall has a pore volume of 0.07 to 0.30 cc/g of pores having a pore diameter of 10 μm or less, an average pore diameter of 11 to 23 μm, and a porosity of 56 to 65%.

[2] The honeycomb filter according to [1], wherein, in the state where the catalyst is not loaded, the partition wall has a pore volume of 0.07 to 0.20 cc/g of pores having a pore diameter of 10 μm or less.

[3] The honeycomb filter according to [1] or [2], wherein, in the state where the catalyst is not loaded, the partition wall has an average pore diameter of 14 to 23 μm.

[4] The honeycomb filter according to any one of [1] to [3], wherein, in the state where the catalyst is not loaded, the partition wall has a porosity of 56 to 63%.

[5] The honeycomb filter according to any one of [1] to [4], wherein the partition wall is made of a material including at least one selected from the group consisting of cordierite, silicon carbide, and aluminum titanate.

[6] The honeycomb filter according to any one of [1] to [5], wherein the catalyst is a three-way catalyst, an oxidation catalyst, or a selective reduction catalyst.

The honeycomb filter according to the present invention can improve exhaust gas purification performance while suppressing an increase in pressure loss. In particular, the honeycomb filter of the present invention can improve exhaust gas purification performance while suppressing an increase in pressure loss without changing the porosity of the partition wall with respect to the conventional honeycomb filter (in other words, while maintaining the same porosity as the conventional honeycomb filter).

### BRIEF DESCRIPTION OF THE DRAWINGS

FIG. 1 is a perspective view schematically showing an embodiment of a honeycomb filter according to the present invention as viewed from a first end face side.

FIG. 2 is a plan view of the honeycomb filter shown in FIG. 1 as viewed from the first end face side.

FIG. 3 is a sectional view schematically showing a section taken along the line A-A′ of FIG. 2.

### DESCRIPTION OF THE PREFERRED EMBODIMENTS

Hereinafter, embodiments of the present invention will be described. However, the present invention is not limited to the following embodiments. Therefore, it should be understood that those created by adding changes, improvements or the like to the following embodiments, as appropriate, on the basis of the common knowledge of one skilled in the art without departing from the spirit of the present invention are also covered by the scope of the present invention.

### (1) Honeycomb Filter:

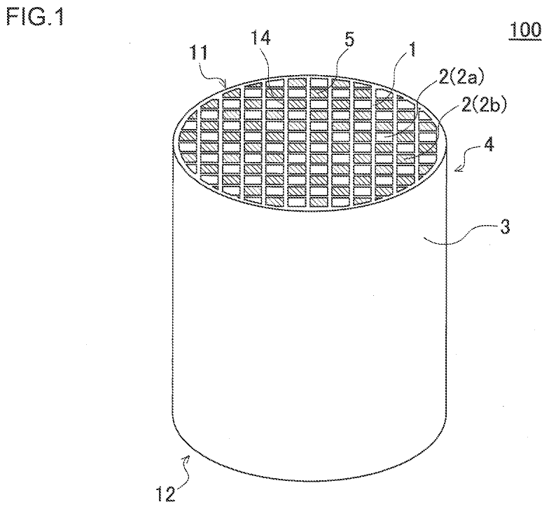

As shown in FIGS. 1 to 3, an embodiment of the honeycomb filter of the present invention is a honeycomb filter 100 including a honeycomb structure 4, plugging portions 5, and a catalyst for purifying exhaust gas 14 loaded on a partition wall 1 of the honeycomb structure 4. The honeycomb structure 4 is of pillar-shaped having a porous partition wall 1 disposed so as to surround a plurality of cells 2 which serve as a fluid through channel extending from a first end face 11 to a second end face 12. In the honeycomb filter 100, the honeycomb structure 4 has a pillar shape, and further includes a circumferential wall 3 at the outer circumferential side surface. In other words, the circumferential wall 3 is provided to encompass the partition wall 1 provided in a grid pattern.

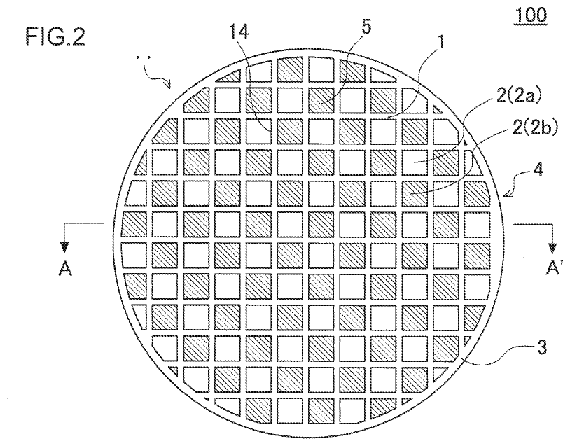

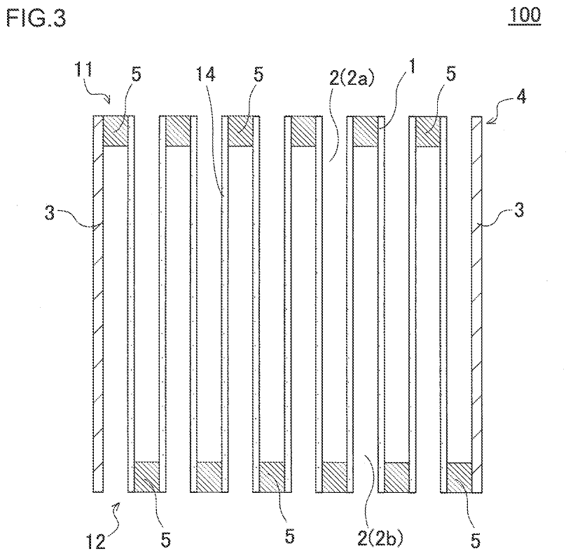

FIG. 1 is a perspective view schematically showing an embodiment of a honeycomb filter of the present invention as viewed from a first end face side (for example, an inflow end face side). FIG. 2 is a plan view of the honeycomb filter shown in FIG. 1 as viewed from the first end face side (for example, the inflow end face side). FIG. 3 is a sectional view schematically showing a section taken along the line A-A′ of FIG. 2.

The honeycomb filter 100 has particularly main properties in the configuration of the partition wall 1 constituting the honeycomb structure 4. That is, in the state where a catalyst 14 is not loaded, the partition wall 1 constituting the honeycomb structure 4 has a pore volume of 0.07 to 0.30 cc/g of pores having a pore diameter of 10 μm or less. The partition wall 1 has an average pore diameter of 11 to 23 μm. In addition, the partition wall 1 has a porosity of 56 to 65%. The honeycomb filter 100 configured as described above can improve exhaust gas purification performance while suppressing an increase in pressure loss. Specifically, by setting the pore volume of pores having a pore diameter of 10 μm or less in the partition wall 1 to 0.07 to 0.30 cc/g, a surface area of the pore loaded with the catalyst 14 in the partition wall 1 is increased. As a result, the exhaust gas purification performance of the honeycomb filter 100 can be improved by increasing the contacting area between the catalyst 14 and exhaust gas while securing the catalyst loaded volume capable of achieving excellent exhaust gas purification performance. Further, by setting the average pore diameter of the partition wall 1 to 11 to 23 μm and the porosity to 56 to 65%, it is possible to effectively suppress an increase in pressure loss while improving exhaust gas purification performance as described above. Hereinafter, the properties of the partition wall 1 described above will be described in more detail.

In the pore volume of the partition wall 1, the partition wall 1 has a pore volume of 0.07 to 0.30 cc/g of pores having a pore diameter of 10 μm or less. The pore volume of pores having a pore diameter of 10 μm or less in the partition wall 1 is measured by the mercury press-in method. The pore volume (cc/g) of pores having a pore diameter of 10 μm or less in the partition wall 1 can be measured using, for example, Autopore 9500 (trade name) manufactured by Micromeritics. When the pore volume of pores having a pore diameter of 10 μm or less is less than 0.07 cc/g, a surface area of the pore loaded with the catalyst 14 is reduced, and it is difficult to sufficiently improve exhaust gas purification performance. On the other hand, when the pore volume of pores having a pore diameter of 10 μm or less exceeds 0.30 cc/g, if the average pore diameter and the porosity of the partition wall 1 are set to the numerical values described above, pressure loss increases. The pore volume of pores having a pore diameter of 10 μm or less may be 0.07 to 0.30 cc/g, but is preferably 0.07 to 0.20 cc/g, and more preferably 0.07 to 0.15 cc/g, for example.

The partition wall 1 has an average pore diameter of 11 to 23 μm. The average pore diameter of the partition wall 1 is a value measured by a mercury press-in method. The average pore diameter of the partition wall 1 can be measured using Autopore 9500 (trade name) manufactured by Micromeritics, for example. When the average pore diameter of the partition wall 1 is less than 11 μm, if the average pore diameter and the porosity of the partition wall 1 are set to the numerical values described above, pressure loss increases. On the other hand, when the average pore diameter of the partition wall 1 exceeds 23 μm, trapping performance of the honeycomb filter 100 deteriorates. The average pore diameter of the partition wall 1 may be 11 to 23 μm, for example, preferably 14 to 23 μm, and more preferably 15 to 23 μm.

Furthermore, the partition wall 1 has a porosity of 56 to 65%. The porosity of the partition wall 1 is a value measured by mercury press-in method. The porosity of the partition wall 1 can be measured using Autopore 9500 (trade name) manufactured by Micromeritics, for example. When the partition wall 1 has a porosity of less than 56%, if the average pore diameter and the porosity of the partition wall 1 are set to the numerical values described above, pressure loss increases. On the other hand, when the porosity of the partition wall 1 exceeds 65%, the mechanical strength (e.g., isostatic strength) of the honeycomb filter 100 decreases. The porosity of the partition wall 1 may be 56 to 65%, for example, preferably 56 to 63%, and more preferably 56 to 62%.

To measure the pore volume (cc/g), the average pore diameter (μm), and the porosity (%) of pores having a pore diameter of 10 μm or less in the partition wall 1 as described above, a part of the partition wall 1 is cut out from the honeycomb filter 100 to obtain a test piece, and the test piece thus obtained can be used.

The thickness of the partition wall 1 is not particularly limited, but is preferably 0.203 to 0.406 mm, more preferably 0.229 to 0.356 mm, and particularly preferably 0.254 to 0.330 mm, for example. If the thickness of the partition wall 1 is less than 0.203 mm, for example, the mechanical strength of the partition wall 1 may decrease. On the other hand, if the thickness of the partition wall 1 exceeds 0.406 mm, when the catalyst for purifying exhaust gas is loaded on the partition wall 1, pressure loss of the honeycomb filter 100 may increase. The thickness of the partition wall 1 can be measured with a scanning electron microscope or a microscope, for example.

The shape of the cells 2 formed in the honeycomb structure 4 is not particularly limited. For example, the shape of the cells 2 in the section that is orthogonal to the extending direction of the cells 2 may be polygonal, circular, elliptical or the like. A polygonal shape may be triangular, quadrangular, pentagonal, hexagonal, octagonal, or the like. The shape of the cells 2 is preferably triangular, quadrangular, pentagonal, hexagonal or octagonal. Further, regarding the shapes of the cells 2, all the cells 2 may have the same shape or different shapes. For example, although not shown, quadrangular cells and octagonal cells may be mixed. Further, regarding the sizes of the cells 2, all the cells 2 may have the same size or different sizes. For example, although not shown, among the plurality of cells, some cells may be larger and other cells may be relatively smaller. In the present invention, the cells 2 mean a space surrounded by the partition wall 1.

The cell density of the cells 2 defined by the partition wall 1 is preferably 31 to 70 cells/cm², more preferably 39 to 54 cells/cm². The honeycomb filter 100 with this configuration can be used favorably as a filter to purify exhaust gas emitted from an automobile engine.

The partition wall 1 is preferably made of a ceramic porous material, and more preferably made of a material containing at least one selected from the group consisting of cordierite, silicon carbide, and aluminum titanate. The material consistuting the partition wall 1 preferably contains 30% by mass or more, and more preferably 40% by mass or more, of the components contained in the group described above (i.e., cordierite, silicon carbide, and aluminum titanate).

The circumferential wall 3 of the honeycomb structure 4 may be configured integrally with the partition wall 1 or may be a circumferential coat layer formed by applying a circumferential coating material on the circumferential side of the partition wall 1. For example, although not shown, the circumferential coat layer can be provided on the circumferential side of the partition wall after the partition wall and the circumferential wall are integrally formed and then the formed circumferential wall is removed by a publicly known method, such as grinding, in a manufacturing process.

The shape of the honeycomb structure 4 is not particularly limited. The honeycomb structure 4 may be pillar-shaped in which the shape of the first end face 11 (e.g., inflow end face) and the shape of the second end face 12 (e.g., outflow end face) are circular, elliptical, polygonal, or the like.

The size of the honeycomb structure 4, for example, the length from the first end face 11 to the second end face 12, and the size of the section that is orthogonal to the extending direction of the cell 2 of the honeycomb structure 4 are not particularly limited. Each size may be selected as appropriate such that optimum purification performance is obtained when the honeycomb filter 100 is used as a filter for purifying exhaust gas.

In the honeycomb filter 100, the plugging portions 5 are provided at the open ends on the first end face 11 side of predetermined cells 2 and at the open ends on the second end face 12 side of the remaining cells 2. If the first end face 11 is defined as the inflow end face, and the second end face 12 is defined as the outflow end face, then the cells 2 which have the plugging portions 5 provided at the open ends on the outflow end face side and which have the inflow end face side open are defined as inflow cells 2a. Further, the cells 2 which have the plugging portions 5 provided at the open ends on the inflow end face side and which have the outflow end face side open are defined as outflow cells 2b. The inflow cells 2a and the outflow cells 2b are preferably arranged alternately with the partition wall 1 therebetween. This, in addition, preferably forms a checkerboard pattern by the plugging portions 5 and “the open ends of the cells 2” on both end faces of the honeycomb filter 100.

The material of the plugging portion 5 is not particularly limited. For example, the material may be the same as the material of the partition wall 1 described above, or may be a material different from the material of the partition wall 1.

In the honeycomb filter 100, the partition wall 1 defining a plurality of cells 2a is loaded with a catalyst for purifying exhaust gas 14. The “partition wall 1 is loaded with a catalyst 14” means that the catalyst 14 is coated on the surface of the partition wall 1 and the inner wall of the pore formed on the partition wall 1. With this configuration, hydrocarbons (HC), carbon monoxide (CO), nitrogen oxides (NOx), and the like in exhaust gas can be made harmless by a catalytic reaction. In addition, oxidization of PM such as soot trapped by the partition wall 1 can be promoted.

The catalyst 14 loaded on the partition wall 1 is not particularly limited. For example, such catalysts 14 may include a three-way catalyst, an oxidation catalyst, and a selective reduction catalyst.

The three-way catalyst refers to a catalyst that mainly purifies hydrocarbons (HC), carbon monoxide (CO), and nitrogen oxides (NOx). Examples of the three-way catalyst include catalysts containing platinum (Pt), palladium (Pd), and rhodium (Rh).

Examples of the oxidation catalyst include one containing noble metals. Specifically, the oxidation catalyst preferably contains at least one selected from the group consisting of platinum, palladium, and rhodium.

The selective reduction catalyst is a catalyst that selectively reduces a component to be purified. The selective reduction catalyst is also referred to as a “SCR catalyst”. “SCR” is an abbreviation for “Selective Catalytic Reduction”. Examples of the SCR catalyst include a SCR catalyst for selective reduction of NOx that selectively reduces NOx in exhaust gas. For example, SCR catalyst can include metal-substituted zeolites. Examples of the metal for metal-substituting the zeolite include iron (Fe) and copper (Cu). Preferable examples of the zeolite include beta zeolite.

The amount of the catalyst 14 loaded on the partition wall 1 (hereinafter, referred to as a “loading amount” of the catalyst 14) is not particularly limited. For example, the loading amount of the catalyst 14 is preferably 50 to 150 g/L, and more preferably 70 to 140 g/L. In this specification, the loading amount (g/L) of the catalyst 14 indicates the amount (g) of the catalyst loaded per unit volume (L) of the honeycomb filter 100.

### (2) Manufacturing Method of Honeycomb Filter

The manufacturing method of the honeycomb filter of the present embodiment shown in FIGS. 1 to 3 is not particularly limited, and the honeycomb filter can be manufactured by the following method, for example. First, a plastic kneaded material for making a honeycomb structure is prepared. The kneaded material for making a honeycomb structure can be prepared, for example, as follows. Silicon carbide, silicon-bonded silicon carbide, a binder sintered ceramic material, mullite, cordierite, cordierite forming raw material, aluminum titanate, and the like can be used as raw material powders. The “silicon-bonded silicon carbide” means, for example, one in which silicon carbide particles as an aggregate are bonded by metallic silicon. In addition, the “binder sintered ceramic material” means a ceramic material made by sintering, in which aggregate such as silicon carbide and mullite are bonded together by a binder such as cordierite. The cordierite forming raw material is prepared by mixing raw materials such as talc, kaolin, alumina, silica, and aluminium hydroxide at a predetermined ratio such that the chemical composition is 42 to 56% by mass of SiO₂, 30 to 45% by mass of Al₂O₃, and 12 to 16% by mass of MgO.

The honeycomb filter of the present embodiment has the main properties in the configuration of the porous partition wall (in particular, the configuration of the porous pores and micropores). As a method for manufacturing such a honeycomb filter, for example, in the preparation of a kneaded material, a mixed raw material obtained by mixing silicon carbide (SiC) powder and metallic silicon (Si) at a mass ratio of 80:20 is prepared. Then, as a pore former to be added to the mixed material, several types of pore formers having different average particle diameters are selected from several types of pore formers having average particle diameters of 25 to 45 μm. Several types of pore formers are added to the mixed raw material prepared previously so that the blending ratio of the pore former having a smaller average particle diameter among the selected pore formers is higher, to prepare the kneaded material. Thus, it is preferred that the pore former added to the mixed raw material in the preparation of the kneaded material exhibits a unimodal or multimodal particle size distribution in which the distribution is biased toward the small diameter side when viewed as a whole pore former.

Next, the kneaded material thus obtained is subjected to extrusion so as to make a honeycomb formed body having a partition wall defining a plurality of cells and a circumferential wall disposed so as to encompass the partition wall.

The obtained honeycomb formed body is dried, for example, by microwave and hot air, and an open end of the cell is plugged with a material similar to the material used for making the honeycomb formed body to provide a plugging portion. After forming the plugging portion, the honeycomb formed body may be dried again.

Next, a honeycomb formed body in which the plugging portion have been formed is fired to manufacture a honeycomb filter before being loaded with a catalyst (hereinafter, also referred to as a “honeycomb filter before catalyst loading”). The firing temperature and the firing atmosphere differ according to the raw material, and those skilled in the art can select the firing temperature and the firing atmosphere that are the most suitable for the selected material.

Next, the catalyst for purifying exhaust gas is loaded on the prepared honeycomb filter before catalyst loading. The method of loading the catalyst is not particularly limited, and examples thereof include a method in which a catalyst slurry containing catalyst components is wash coated and then heat-treated at a high temperature to be baked. As described above, the honeycomb filter of the present embodiment can be manufactured.

### Examples

The following will describe the present invention more specifically by examples, but the present invention is not at all limited by these examples.

### Example 1

As a raw material powder for adjusting a kneaded material, a mixed raw material was prepared by mixing silicon carbide (SiC) powder and metallic silicon (Si) at a mass ratio of 80:20. To 100 parts by mass of the mixed raw material, 25 parts by mass of a pore former, a trace amount of a dispersing agent, and 7 parts by mass of an organic binder were added, mixed, and kneaded to prepare a kneaded material. As the organic binder, methylcellulose was used. As the dispersing agent, polyethylene glycol monooleate was used. As the pore former, a pore former, which was prepared so that several pore formers with differing average particle diameter were selected from several pore formers with an average particle diameter of 25 to 45 μm, and the blending ratio of the pore former with smaller average particle diameter was larger, was used.

Next, the obtained kneaded material was molded using an extruder to make a honeycomb formed body. Next, the obtained honeycomb formed body was dried by high frequency dielectric heating, and then further dried using a hot air dryer. The shape of the cells in the honeycomb formed body was quadrangular.

Next, a plugging portion was formed on the dried honeycomb formed body. First, the inflow end face of the honeycomb formed body was masked. Next, an end portion provided with a mask (the end portion on the inflow end face side) was immersed in a plugging slurry, and the plugging slurry was filled into an open end of the cell without the mask (the outflow cell). In this way, a plugging portion was formed on the inflow end face of the honeycomb formed body. Then, the plugging portion was also formed in the inflow cell in the same manner for the outflow end face of the dried honeycomb formed body.

Next, the honeycomb formed body on which the plugging portions have been formed was dried with a microwave dryer and completely dried with a hot air dryer, and then both end faces of the honeycomb formed body were cut and adjusted to a predetermined size. The dried honeycomb formed body was then degreased and calcined to manufacture a honeycomb filter before loading catalyst.

The honeycomb filter before loading catalyst had a diameter of the end face of 165 mm and a length in the extending direction of the cell of 140 mm. The thickness of the partition wall was 0.318 mm and the cell density was 46.5 cells/cm².

The porosity (%) and the average pore diameter (μm) of the partition wall of the honeycomb filter before loading catalyst were measured in the following manner. In addition, a pore diameter distribution of the partition wall was obtained using a device used for measuring the porosity and the average pore diameter shown below, and the pore volume (cc/g) of pores having a pore diameter of 10 μm or less was obtained from the obtained pore diameter distribution. Table 1 shows the results.

TABLE 1

| | | | Pore | | | | | |
|---|---|---|---|---|---|---|---|---|
| | | | volume of | | | | | |
| | | Average | pores of | | | | | |
| | | pore | 10 μm or | Exhaust gas | | | | |
| | Porosity | diameter | less | purification | Isostatic | Pressure | Trapping | Comprehensive |
| | (%) | (μm) | (cc/g) | performance | strength | loss | performance | judgment |
| Comparative | 63 | 20 | 0.05 | Standard | Standard | Standard | Standard | — |
| Example 1 | | | | | | | | |
| Comparative | 63 | 20 | 0.06 | B | A | A | B | Acceptable |
| Example 2 | | | | | | | | |
| Example 1 | 63 | 20 | 0.07 | A | A | A | B | Excellent |
| Example 2 | 63 | 20 | 0.08 | A | A | A | B | Excellent |
| Example 3 | 63 | 20 | 0.13 | A | A | A | B | Excellent |
| Example 4 | 63 | 20 | 0.15 | A | A | A | B | Excellent |
| Example 5 | 63 | 20 | 0.20 | A | A | B | B | Good |
| Example 6 | 63 | 20 | 0.30 | A | A | B | B | Good |
| Comparative | 63 | 20 | 0.35 | A | A | C | B | Acceptable |
| Example 3 | | | | | | | | |
| Comparative | 53 | 20 | 0.08 | A | A | C | B | Acceptable |
| Example 4 | | | | | | | | |
| Example 7 | 56 | 20 | 0.08 | A | A | B | B | Good |
| Example 8 | 58 | 20 | 0.08 | A | A | A | B | Excellent |
| Example 9 | 62 | 20 | 0.08 | A | A | A | B | Excellent |
| Example 10 | 63 | 20 | 0.08 | A | A | A | B | Excellent |
| Example 11 | 65 | 20 | 0.08 | A | B | A | B | Good |
| Comparative | 66 | 20 | 0.08 | A | C | A | B | Acceptable |
| Example 5 | | | | | | | | |

TABLE 2

| | | | Pore | | | | | |
|---|---|---|---|---|---|---|---|---|
| | | | volume of | | | | | |
| | | Average | pores of | | | | | |
| | | pore | 10 μm or | Exhaust gas | | | | |
| | Porosity | diameter | less | purification | Isostatic | Pressure | Trapping | Comprehensive |
| | (%) | (μm) | (cc/g) | performance | strength | loss | performance | judgment |
| Comparative | 63 | 8 | 0.08 | A | A | C | A | Acceptable |
| Example 6 | | | | | | | | |
| Example 12 | 63 | 11 | 0.08 | A | A | B | A | Good |
| Example 13 | 63 | 14 | 0.08 | A | A | A | A | Excellent |
| Example 14 | 63 | 15 | 0.08 | A | A | A | A | Excellent |
| Example 15 | 63 | 20 | 0.08 | A | A | A | B | Excellent |
| Example 16 | 63 | 23 | 0.08 | A | A | A | B | Excellent |
| Comparative | 63 | 25 | 0.08 | A | A | A | C | Acceptable |
| Example 7 | | | | | | | | |

[Porosity (%) and Average Pore Diameter (μm)]

The porosity and the average pore diameter of the partition wall were measured using Autopore 9500 (trade name) manufactured by Micromeritics. In the measurement of the porosity and the average pore diameter, a part of the partition wall was cut out from the honeycomb filter to obtain a test piece, and the porosity was measured using the obtained test piece. The test piece was a rectangular parallelepiped having a length, a width, and a height of approximately 10 mm, approximately 10 mm, and approximately 20 mm, respectively. The sampling location of the test piece was set in the vicinity of the center of the honeycomb structure in the axial direction.

Next, for the honeycomb filter before loading catalyst, the catalyst for purifying exhaust gas was load in the following manner. First, the materials were mixed to prepare a catalyst slurry containing zeolite. The prepared catalyst slurry was then wash coated to the honeycomb filter before loading catalyst. Next, it was dried at 120° C. and then heat-treated at 500° ° C. for 3 hours to bake and load the catalyst to the partition wall of the honeycomb filter. In this way, the honeycomb filter of Example 1 was manufactured. The honeycomb filter of Example 1 had a loading amount of the catalyst of 120 g/L. Table 1 shows the loading amount (g/L) of the catalyst.

The honeycomb filter of Example 1 was evaluated for exhaust gas purification performance, isostatic strength, pressure loss, and trapping performance in the following manner. Based on the above evaluation results, a comprehensive judgement was made by the following method. The results are shown in Table 1.

### (Exhaust Gas Purification Performance)

The exhaust gas purification performance (%) of the honeycomb filter was determined by measuring with a model gas using a catalytic reaction evaluation device. The exhaust gas purification performance can be measured using a FTIR gas analyzer, and examples of the FTIR gas analyzer include a FTIR gas analyzer (model number: MEXA-6000FT) manufactured by HORIBA, Ltd. Exhaust gas performance (%) was calculated by measuring the gaseous levels of nitrogen monoxide and nitrogen dioxide at two locations of the inflow end face side and the outflow end face side of the honeycomb filter. For the model gas, a mixed gas of nitrogen, oxygen, carbon dioxide, carbon monoxide, nitrogen monoxide, ammonia, and water was used, and the evaluation was carried out at the temperature of about 200° C. and the gas flow rate SV=40000(1/h). In the evaluation for exhaust gas purification performance, the honeycomb filters of Examples were evaluated based on the following evaluation criteria.

Evaluation “A”: When the value of the exhaust gas purification performance of the honeycomb filter of Comparative Example 1 is 100%, the value of exhaust gas purification performance of the honeycomb filter to be evaluated is 130% or more.

Evaluation “B”: When the value of the exhaust gas purification performance of the honeycomb filter of Comparative Example 1 is 100%, the value of exhaust gas purification performance of the honeycomb filter to be evaluated is 100% or more and less than 130%.

Evaluation “C”: When the value of the exhaust gas purification performance of the honeycomb filter of Comparative Example 1 is 100%, the value of exhaust gas purification performance of the honeycomb filter to be evaluated is less than 100%.

### (Isostatic Strength)

The isostatic strength (MPa) of the honeycomb filter was determined with a hydrostatic isostatic strength testing device. In the evaluation for isostatic strength, the honeycomb filters of Examples were evaluated based on the following evaluation criteria.

Evaluation “A”: When the value of the isostatic strength of the honeycomb filter of Comparative Example 1 is 100%, the value of the isostatic strength of the honeycomb filter to be evaluated is 90% or more.

Evaluation “B”: When the value of the isostatic strength of the honeycomb filter of Comparative Example 1 is 100%, the value of the isostatic strength of the honeycomb filter to be evaluated is 80% or more and less than 90%.

Evaluation “C”: When the value of the isostatic strength of the honeycomb filter of Comparative Example 1 is 100%, the value of the isostatic strength of the honeycomb filter to be evaluated is less than 80%.

### (Trapping Performance)

Trapping performance (particles/km) of an exhaust gas purification device using the honeycomb filter was determined by the evaluation test on the vehicles. Specifically, the exhaust gas purification device was connected to an outlet side of the engine exhaust manifold of 3.0 L diesel engine vehicle, and the number of soot contained in the gases emitted from the outlet of the exhaust gas purification device was measured by PN measuring method. The “PN measuring method” is a measuring method proposed by Particle Measurement Program (PMP) by the Working Party on Pollution and Energy (GRPE) of the World Forum for Harmonization of Vehicle Regulations (WP29) in the Economic Commission for Europe (ECE) of the United Nations (UN). Specifically, in the determination of the number of soot, the cumulative number of soot discharged after running in the WLTC (Worldwide harmonized Light duty Test Cycle) mode was set as the number of soot in the exhaust gas purification device to be determined (that is, the honeycomb filter used in the exhaust gas purification device). In the evaluation for trapping performance, the honeycomb filters of Examples were evaluated based on the following evaluation criteria.

Evaluation “A”: When the value of the trapping performance of the honeycomb filter of Comparative Example 1 is 100%, the value of the trapping performance of the honeycomb filter to be evaluated is 120% or more.

Evaluation “B”: When the value of the trapping performance of the honeycomb filter of Comparative Example 1 is 100%, the value of the trapping performance of the honeycomb filter to be evaluated is 80% or more and less than 120%.

Evaluation “C”: When the value of the trapping performance of the honeycomb filter of Comparative Example 1 is 100%, the value of the trapping performance of the honeycomb filter to be evaluated is less than 80%.

### (Comprehensive Judgment)

Evaluation “Excellent”: The evaluations for the exhaust gas purification performance, isostatic strength, and pressure loss are all “A”, and the evaluation for trapping performance is “A” or “B”.

Evaluation “Good”: The evaluation for the exhaust gas purification performance is “A” and other evaluations are “A” or “B” (except those falling under “Excellent” evaluations).

Evaluation “Acceptable”: The evaluation for the exhaust gas purification performance is “B” or “C”, or includes the result of “C” in the evaluation other than exhaust gas purification performance.

### Examples 2 to 16

In Examples 2 to 16, honeycomb filters were manufactured using a raw material as shown below in the preparation of a kneaded material for making a honeycomb formed body. In the obtained honeycomb filter, the porosity and the average pore diameter of the partition wall were measured in the same manner as in Example 1. In addition, the pore volume (cc/g) of pores of 10 μm or less was determined by the above-described method. The results are shown in Tables 1 and 2. Note that the honeycomb filters in Example 2, Example 10, and Example 15 are made from the same raw material and have substantially the same properties, but are described as separate examples in Table 1 for convenience of comparison with other Examples.

In Examples 2 to 16, honeycomb filters were manufactured in the same manner as in Example 1, except that the type of the pore former to be selected (i.e., average particle diameter of the pore former to be selected) and the blending ratio thereof were changed in selecting several pore formers with differing average particle diameter from several pore formers with an average particle diameter of 25 to 45 μm. However, in Examples 2 to 16, the pore former is selected so that the blending ratio of the pore former with smaller average particle diameter is larger.

### Comparative Examples 1 to 7

In Comparative Examples 1 to 7, honeycomb filters were manufactured using a raw material as shown below in the preparation of a kneaded material for making a honeycomb formed body. In the obtained honeycomb filter, the porosity and the average pore diameter of the partition wall were measured in the same manner as in Example 1. In addition, the pore volume (cc/g) of pores of 10 μm or less was determined by the above-described methods. The results are shown in Tables 1 and 2. In Comparative Example 1, as a raw material powder for adjusting a kneaded material, a mixed raw material was prepared by mixing silicon carbide (SiC) powder and metallic silicon (Si) at a mass ratio of 80:20. In Comparative Examples 2 to 7, raw material powder was prepared according to the preparation methods of Examples 2 to 4, 5 to 8, 9 to 12, and 13 to 16 as described above.

The honeycomb filters of Examples 2 to 16 and Comparative Examples 1 to 7 were evaluated for exhaust gas purification performance, isostatic strength, pressure loss, and trapping performance in the same manner as in Example 1. Based on the above evaluation results, a comprehensive judgment was made by the following method. The results are shown in Tables 1 and 2.

### Results

It was confirmed that the exhaust gas purification performance was improved with respect to the honeycomb filter of Comparative Example 1 by increasing the pore volume (cc/g) of pores of 10 μm or less as in the honeycomb filters of Examples 1 to 6. However, when the pore volume (cc/g) of pores of 10 μm or less is excessively increased as in the honeycomb filter of Comparative Example 3, pressure loss of the honeycomb filter is significantly increased.

It was found that the increase in pressure loss can be suppressed while keeping the isostatic strength of the honeycomb filter by setting the porosity of the partition wall to a predetermined value as in the honeycomb filters of Examples 7 to 11. On the other hand, it was confirmed that when the porosity of the partition wall was too high, the mechanical strength of the honeycomb filter tends to decrease, although the pressure loss evaluation is good. For example, when the porosity of the partition wall is 66% as in the honeycomb filter of Comparative Example 5, the isostatic strength is greatly reduced, and problems may be occur when canning the honeycomb filter to be housed in a can body such as a metal case. On the other hand, it was found that when the porosity of the partition wall is 53% as in the honeycomb filter of Comparative Example 4, pressure loss of the honeycomb filter is significantly increased, although the isostatic strength is excellent.

The exhaust gas purification performance can be improved while achieving higher trapping performance and suppressing an increase in pressure loss by setting the average pore diameter of the partition wall to a predetermined value as in the honeycomb filters of Example 12 to 16. It was confirmed that when the average pore diameter of the partition wall is too large, the trapping performance tends to deteriorate. On the other hand, it was confirmed that when the average pore diameter of the partition wall is too small, pressure loss tends to increase.

### INDUSTRIAL APPLICABILITY

The honeycomb filter according to the present invention can be used as a trapping filter for removing particulates and the like contained in exhaust gas.

### DESCRIPTION OF REFERENCE NUMERALS

1: partition wall, 2: cell, 2a: inflow cell, 2b: outflow cell, 3: circumferential wall, 4: honeycomb structure, 5: plugging portion, 11: first end face, 12: second end face, 14: catalyst, and 100: honeycomb filter.

What is claimed is:

1. A honeycomb filter comprising: a pillar-shaped honeycomb structure having a porous partition wall disposed so as to surround a plurality of cells which serve as a fluid through channel extending from a first end face to a second end face; a plugging portion provided at either an end on the first end face side or the second end face side of the cell; and a catalyst for purifying exhaust gas that is loaded on the partition wall; wherein, in the state where the catalyst is not loaded, the partition wall has a pore volume of 0.07 to 0.30 cc/g of pores having a pore diameter of 10 μm or less, an average pore diameter of 11 to 23 μm, and a porosity of 56 to 65%.

2. The honeycomb filter according to claim 1, wherein, in the state where the catalyst is not loaded, the partition wall has a pore volume of 0.07 to 0.20 cc/g of pores having a pore diameter of 10 μm or less.

3. The honeycomb filter according to claim 1, wherein, in the state where the catalyst is not loaded, the partition wall has an average pore diameter of 14 to 23 μm.

4. The honeycomb filter according to claim 1, wherein, in the state where the catalyst is not loaded, the partition wall has a porosity of 56 to 63%.

5. The honeycomb filter according to claim 1, wherein the partition wall is made of a material comprising at least one selected from the group consisting of cordierite, silicon carbide, and aluminum titanate.

6. The honeycomb filter according to claim 1, wherein the catalyst is a three-way catalyst, an oxidation catalyst, or a selective reduction catalyst.
